(19) United States
(12) Patent Application Publication
(10) Pub. No.: US 2006/0013451 A1
(43) Pub. Date: Jan. 19, 2006

(54) Audio data fingerprint searching

(75) Inventor: Jaap Andre Haitsma, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/533,211

(22) PCT Filed: Oct. 7, 2003
(86) PCT No.: PCT/IB03/04404

§ 371 Date: Apr. 28, 2005

(30) Foreign Application Priority Data
Nov. 1, 2002 (EP) 02079578.7

(51) Int. Cl. G06K 9/00

(52) U.S. Cl. 382/124

(57) ABSTRACT

Methods and apparatus are described for matching a set input fingerprint blocks, each fingerprint block representing at least a part of an information signal, with fingerprints stored in a database that identify respective information signals. The method includes selecting a first fingerprint block of the set of input fingerprint blocks (10), and finding at least one fingerprint block in the database that matches the selected fingerprint block (20, 40). A further fingerprint block is then selected from the set of input blocks (60), at a predetermined position from the first selected fingerprint block. A corresponding fingerprint block is then located in the database at the same predetermined position relative to the found fingerprint block (70), and it is determined if the located fingerprint block matches the selected further fingerprint block (80).

### FIELD OF THE INVENTION

The invention relates to methods and apparatus suitable for matching a fingerprint with fingerprints stored in a database.

### BACKGROUND OF THE INVENTION

Hash functions are commonly used in the world of cryptography where they are commonly used to summarise and verify large amounts of data. For instance, the MD5 algorithm, developed by Professor R L Rivest of MIT (Massachusetts Institute of Technology), has as an input a message of arbitrary length and produces as an output a 128-bit “fingerprint”, “signature” or “hash” of the input. It has been conjectured that it is statistically very unlikely that two different messages have the same fingerprint. Consequently, such cryptographic fingerprint algorithms are a useful way to verify data integrity.

In many applications, identification of multimedia signals, including audio and/or video content, is desirable. However, multimedia signals can frequently be transmitted in a variety of file formats. For instance, several different file formats exist for audio files, like WAV, MP3 and Windows Media, as well as a variety of compression or quality levels. Cryptographic hashes such as MD5 are based on the binary data format, and so will provide different fingerprint values for different file formats of the same multimedia content. This makes cryptographic hashes unsuitable for summarising multimedia data, for which it is required that different quality versions of the same content yield the same hash, or at least similar hash. Hashes of multimedia content have been referred to as robust hashes (e.g. in “Robust Audio Hashing for Content Identification”, Content Based Multimedia Indexing 2001, Brescia, Italy, September 2001, by Jaap Haitsma, Ton Kalker and Job Oostveen) but are now commonly referred to as multimedia fingerprints.

Fingerprints of multimedia content that are relatively invariant to data processing (as long as the processing retains an acceptable quality of the content), are referred to as robust summaries, robust signatures, robust fingerprints, perceptual or robust hashes. Robust fingerprints capture the perceptually essential parts of audio-visual content, as perceived by the Human Auditory System (HAS) and/or the Human Visual System (HVS).

One definition of a multimedia fingerprint is a function that associates with every basic time-unit of multimedia content a semi-unique bit-sequence that is continuous with respect to content similarity as perceived by the HAS/HVS. In other words, if the HAS/HVS identifies two pieces of audio, video or image as being very similar, the associated fingerprints should also be very similar. In particular, the fingerprints of original content and compressed content should be similar. On the other hand, if two signals really represent different content, the robust fingerprint should be able to distinguish the two signals (semi-unique). Consequently, multimedia fingerprinting enables content identification, which is the basis for many applications.

For instance, in one application, the fingerprints of a large number of multimedia objects, along with the associated meta-data of each object, are stored in a database. The meta-data is normally information about the object, rather than information about the object content e.g. if the object is an audio clip of a song, then the meta-data might include song title, artist, composer, album, length of clip and position of clip in the song.

Typically, a single fingerprint value or term is not calculated for the whole of a complete multimedia signal. Instead, a number of fingerprints (hereinafter referred to as sub-fingerprints) are calculated for each of a number of segments of a multimedia signal e.g. a sub-fingerprint is calculated for each picture frame (or portion of a picture frame), or a time slice of an audio track. Consequently, a fingerprint of an audio track such as a song is simply a list of sub-fingerprints.

A fingerprint-block is a sequence of sub-fingerprints (typically 256) which contains enough information to reliably identify the information source (e.g. a song). In principle a fingerprint block of a song can be any block of subsequent sub-fingerprints of the song. Typically, a number of fingerprint blocks are formed for each song, each block representing a contiguous section of the song.

If multimedia content is subsequently received without any meta-data, then the meta-data of the multimedia content can be determined by computing one or more fingerprint blocks of the multimedia content, and finding the corresponding fingerprint block(s) in the database. Matching of fingerprint blocks, rather than the multimedia content itself; is much more efficient as less memory/storage is required, as perceptual irrelevancies are typically not incorporated within the fingerprints.

Matching of an extracted fingerprint block (from the received multimedia content) to the fingerprint blocks stored in the database can be performed by performing a brute force search, so as to match the fingerprint block (or fingerprint blocks if the length of the received signal is sufficiently long) of the received signal to each of the fingerprint blocks in the database.

The article “Robust Audio Hashing for Content Identification”, Content Based Multimedia Indexing 2001, Brescia, Italy, September 2001, by Jaap Haitsma, Ton Kalker and Job Oostveen, describes a suitable audio fingerprint search technique. The described strategy utilises a look up table for all possible sub-fingerprint values. The entries in the table point to the song(s) and the position(s) in that song where the respective sub-fingerprint value occurs. By inspecting the look up table for each of the extracted sub-fingerprint values, a list of candidate songs and positions is generated, so as to efficiently narrow down the scope of the matching of the fingerprint blocks required.

It is an aim of embodiments of the present invention to provide methods and apparatus for allowing efficient searching of a database of fingerprints.

### STATEMENT OF THE INVENTION

In a first aspect, the present invention provides a method of matching a set of input fingerprint blocks, each fingerprint block representing at least a part of an information signal, with fingerprints stored in a database that identify respective information signals, the method comprising the steps of: selecting a first fingerprint block of said input set of fingerprint blocks; finding at least one fingerprint block in said database that matches the selected fingerprint block; selecting a further fingerprint block from said set of fingerprint blocks at a predetermined position relative to said first selected fingerprint block; locating at least one corresponding fingerprint block in said database at the predetermined position relative to said found fingerprint block; and determining if said located fingerprint block matches said selected further fingerprint block.

Searching in this manner can thus efficiently reduce the search speed and/or increase the robustness, by using an initial match to significantly narrow the scope of the search, and subsequently matching fingerprint blocks in corresponding positions.

In another aspect, the present invention provides a method of generating a logging report for an information signal comprising the steps of: dividing the information signal into similar content segments; generating an input fingerprint block for each segment; and repeating the method steps as described above so as to identify each of said blocks.

In a further aspect, the present invention provides a computer program arranged to perform the method as described above.

In another aspect, the present invention provides a record carrier comprising a computer program as described above.

In a further aspect, the present invention provides a method of making available for downloading a computer program as described above.

In another aspect, the present invention provides an apparatus arranged to match a set of input fingerprint blocks, each fingerprint block representing at least a part of an information signal, with fingerprints stored in a database that identify respective information signals, the apparatus comprising a processing unit arranged to: select a first fingerprint block of said set of input fingerprint blocks; find at least one fingerprint block in said database that matches the selected fingerprint block; select a further fingerprint block from said set of input blocks at a predetermined position relative to said first selected fingerprint block; locate at least one corresponding fingerprint block in said database at the predetermined position relative to said found fingerprint block; and determine if said located fingerprint block matches said selected further fingerprint block.

Further features of the invention are defined in the dependent claims.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 is a flow chart of the method steps of a first embodiment of the present invention;

FIG. 2 is a diagram illustrating fingerprint blocks corresponding to segments of an audio signal for selection for searching according to an embodiment of the present invention;

FIG. 3 is a flow chart of the method steps of a second embodiment;

FIG. 4 is a schematic diagram of an arrangement for generating a fingerprint block value from an input information stream, and subsequently matching the fingerprint block in accordance with a further embodiment of the present invention.

### DESCRIPTION OF PREFERRED EMBODIMENTS

Typically, identification of fingerprint blocks by matching them with fingerprints stored in a database requires what we will refer to as a full search (e.g. by using the search technique described in “Robust Audio Hashing for Content Identification”, Content Based Multimedia Indexing 2001, Brescia, Italy, September 2001, by Jaap Haitsma, Ton Kalker and Job Oostveen).

The present invention exploits the fact that the probability that subsequent (or previous) fingerprint blocks originate from the same information segment (e.g. song or video clip) is high. Consequently, once one fingerprint block has been identified, subsequent fingerprint blocks can be quickly identified by attempting to match them with only the corresponding fingerprint blocks in the database.

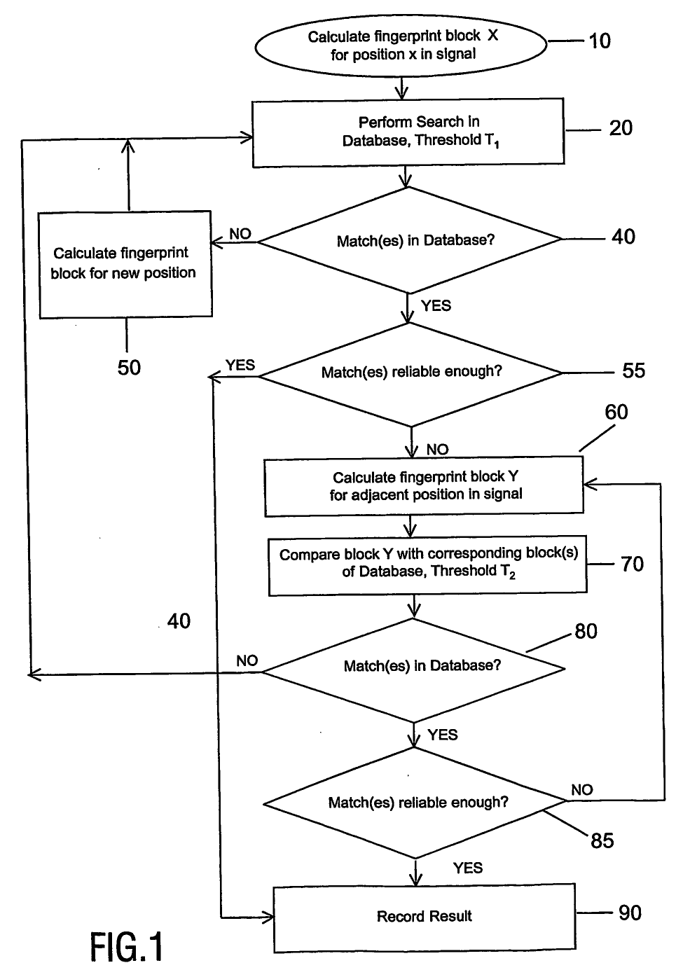

FIG. 1 illustrates a flow chart of the steps involved in performing such a search in accordance with a first embodiment of the invention.

The search assumes that a database exists that contains a number of fingerprints corresponding to different sections of an information signal. For instance, the database might contain fingerprint blocks of a large number of songs, with each fingerprint block comprising a sequence of sub-fingerprints. A sub-fingerprint corresponds to a short segment (e.g. 11.8 milli-seconds) of the song. Meta-data is associated with each song, indicative of, for instance, song title, song length, performing artist(s), composer, recording company etc.

An information signal (e.g. a song, or portion of a song) is received, and it is desirable to identify the song and/or meta-data associated with the song. This can be achieved by matching fingerprint blocks of the song to corresponding fingerprint blocks in the database.

As indicated in FIG. 1, a first fingerprint block X is calculated for a first position x in the information signal (step 10). For instance, in a song, this could relate to a time slice of between 3-5 seconds within the song.

A search is then performed of the database, to identify whether any of the fingerprint blocks in the database match the calculated fingerprint block X (step 20).

Such a search (step 20) could be an exhaustive search of the database, iteratively comparing fingerprint block X with every fingerprint block within the database. Alternatively, a look-up table can be used to select the likeliest matches, as described in the article “Robust Audio Hashing For Content Identification”, Content Based Multimedia Indexing 2001, Brescia, Italy, September 2001, by Jaap Haitsma, Ton Kalker and Job Oostveen.

Due to variations in the framing of the signal time slots, and signal degradation due to transmission and/or compression, it is unlikely that the fingerprint block X will exactly match any single fingerprint block stored in the database. However, a match is assumed to occur (step 20) if the similarity between the fingerprint block X and any one of the fingerprint blocks in the database is high enough.

Equivalently, the dissimilarity (e.g. number of differences) between the fingerprint block X and the fingerprint blocks in the database can be compared. If the dissimilarity (the number of differences between the two fingerprint blocks) is below a predetermined threshold T₁ then a match is assumed to have occurred.

If no matching fingerprint blocks are determined to exist in the database (step 40), then a fingerprint block is calculated for a new start position within the signal (step 50), and the search re-performed (steps 20 and 40).

If one or possibly more (this can occur if two songs are very similar) fingerprint blocks are found to be similar, then their positions in the database are noted. If the reliability of the match is large enough (step 55) the result can be recorded (step 90) and the identification process can be stopped. If the match is not reliable enough, a fingerprint block Y can be determined for an adjacent position to position x in the signal (e.g. the previous or subsequent time slice of the audio signal), step 60.

The fingerprint block(s) of the corresponding position(s) in the database are then compared with fingerprint block Y (step 70). For instance, if fingerprint block Y was calculated for the time slot immediately after position x in the audio signal, then the fingerprint block Y would be compared with the fingerprint block(s) in the database that would be expected to occur immediately after the fingerprint block(s) that matched fingerprint block X.

Again, the matching of fingerprint blocks would be performed using a predetermined threshold (T₂) relating to the dissimilarity between the fingerprint blocks. Threshold T₂ could be the same as T₁, or even lower than T₁. Preferably however, T₂ is a slightly higher threshold than T₁. It is extremely unlikely that two adjacent fingerprint blocks will match two adjacent fingerprint blocks in the database, unless the blocks relate to the same information source. If fingerprint block Y does not match the corresponding fingerprint block in the database (this can for instance happen if a new song has started playing) a full search can be performed for fingerprint block Y.

If there are no matches in the database (step 80), then the search process is restarted i.e. a full search is performed of the database for a match of the current block Y (step 20), and the subsequent steps repeated as appropriate.

If one or more of the corresponding fingerprint blocks in the database do match (step 80), it is determined if any of the matches are reliable (step 85) e.g. is any match good enough to reliably identify the information signal. If a match is reliable the result is recorded (step 90) and the identification process is stopped. If not, a new fingerprint block Y determined (step 60) for the next adjacent time slot in the signal (i.e. adjacent to the position of the previous fingerprint block Y).

It will be appreciated that the above embodiment is provided by way of example only. For instance, the embodiment has been described with reference to an information signal being received, and fingerprint blocks being calculated for positions within the information signal (steps 10, 50, 60) as the search is performed. Equally, the search technique is applicable to an information signal being received, and fingerprint blocks calculated (prior to the start of the search) for one or more positions (up to every position) in the signal, the blocks being subsequently selected for use in the search process. Alternatively, simply two or more single fingerprint blocks corresponding to at least a portion of an information signal could be received, and searches performed utilising these fingerprint blocks to identify the original information signal.

The matching thresholds can be varied in dependence upon the search being conducted. For instance if it is anticipated that the information signal is likely to be distorted, the threshold T₁ can be set higher than normal, in order to be more robust against distortions and decrease the false negative rate (a false negative is assumed to have occurred if two fingerprint blocks are determined not to match, even though they relate to the same portion of the information signal). Decreasing the false negative rate generally leads to a higher false positive rate (in which a match is deemed to have occurred between two fingerprint blocks that actually relate to different information). However, the false positive rate can be decreased for the overall search, by taking into account whether the next (or previous) fingerprint block matches to the corresponding blocks in the database.

The above method has assumed that each subsequent fingerprint block selected for matching from the information signal is adjacent (either before or after in sequence) to the previously fingerprint block. However, it will be appreciated that the same method can be used if the information to which the fingerprint block corresponds is adjacent to the information of the previously selected fingerprint block. Equally, any known relationship between fingerprint blocks of the information signal, or positions of information to which the fingerprint blocks relate can be utilised, as long as the relationship is such that a fingerprint block with a corresponding position can be located within the database. For instance, in an information signal comprising an image a search could be performed upon fingerprint blocks corresponding to image segments along the diagonal of the image.

Embodiments of the invention can also be used to monitor wireless or wireline broadcasts of songs or other musical works. For instance, an audio fingerprinting system can be used to generate a logging report for all time blocks (typically of the order of 3-5 seconds) present in an audio stream, which can consist of multiple songs. The log information for one segment usually includes song, artist, album, and position in the song.

The monitoring process can be done offline i.e. the fingerprint blocks of an audio stream (e.g. a radio station broadcast) are first recorded to a fingerprint file containing for example the fingerprint blocks of an hour of audio. The log for this hour of audio can be generated efficiently by using the above method.

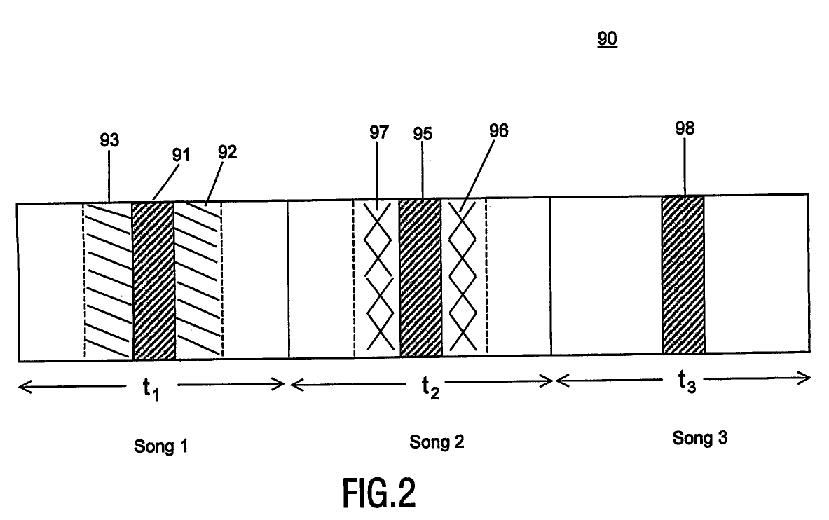

FIG. 2 illustrates a fingerprint file 90 including fingerprint blocks for three songs (song 1, song 2, song 3), each song lasting a respective time (t₁, t₂, t₃). Instead of performing a full search on all of the fingerprint blocks, a full search is performed on only a small set of fingerprint blocks (e.g. 91, 95 and 98), which are preferably spaced either an average song length apart (around 3-4 minutes) or a minimum song length apart (e.g. 2 minutes apart, assuming that the minimum song length is known to be equal to or greater than 2 minutes). Typically, a sub-fingerprint will last around 10 milliseconds, and a fingerprint block 3-5 seconds.

Once a fingerprint block out of the small set (91, 95 98) is identified, then neighbouring blocks (92, 93, 96, 97 . . . ) can be identified very efficiently by only matching the corresponding fingerprint blocks in the database, using the method described with reference to FIG. 1. The corresponding blocks can be identified by using the song position of the identified block and the song length of the identified song. After performing the matches, a new fingerprint block out of the set of unidentified blocks is selected for a full search. The whole procedure repeats itself until all of the fingerprint blocks have been positively identified by either a match, or a full search has identified the fingerprint blocks as unknown.

It should be noted that embodiments of the invention can also be used for real time monitoring. For instance, an embodiment could be used to identify songs on the radio almost instantaneously, as the songs are played. In that case only fingerprint blocks after an already identified fingerprint block can easily be used for matching with corresponding blocks in the database. However, if some delay is allowed between receiving the current block and identifying the information source, then a number of previous fingerprint blocks can also be used in the identification process.

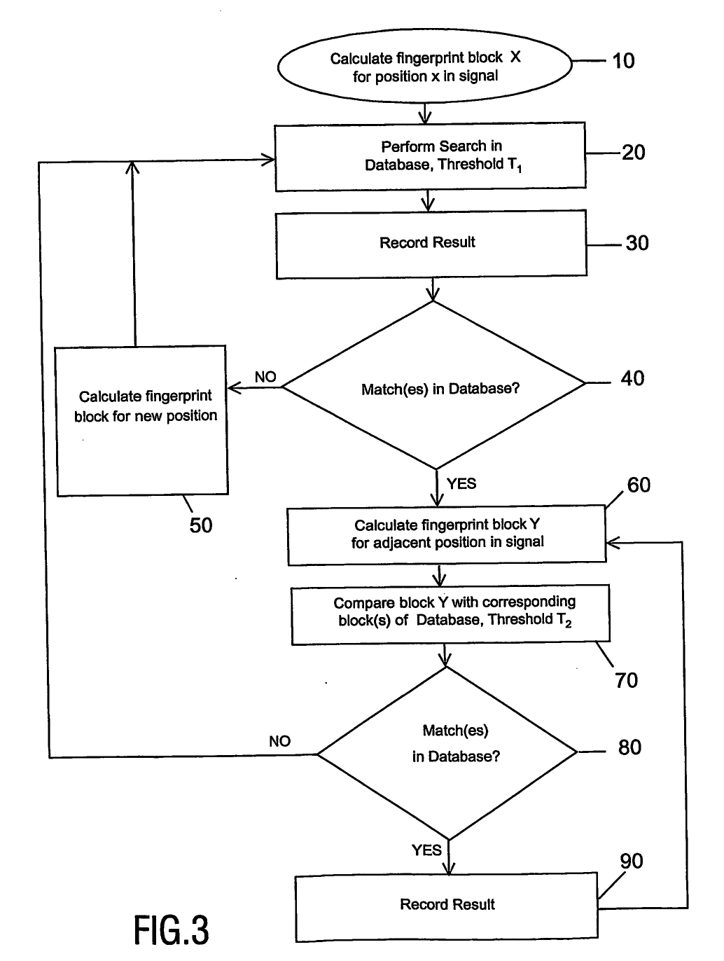

FIG. 3 shows a flow chart of the method steps for an embodiment of the present invention suitable for use in performing such real time monitoring of information signals.

Within FIG. 3, identical reference numerals have been utilised for method steps that correspond to the same method steps in FIG. 1.

Initially, a fingerprint block X is calculated for position x in the signal (step 10). A search is then performed in the database for matching fingerprint blocks, at a first threshold T₁ (step 20) and its result is recorded (step 30).

If no matching blocks are found in the database (step 40), then a fingerprint block is calculated for a new position in the information signal (step 50), and the search performed again (step 20).

If one or more matching fingerprint blocks are found within the database (step 40), a fingerprint block Y is calculated for an adjacent position in the information signal (step 60). For instance, if the information signal is being continuously received, then the fingerprint block Y could be calculated for the next received time slice of the signal.

Block Y is then compared with the corresponding blocks of the database, at a second threshold T₂ (step 70). In other words, block Y is only compared with those block(s) of the database that relate to positions in the information signals adjacent to the positions of the blocks found in step 20 to match block X.

If block Y is found not to match any of the corresponding blocks of the database (step 80), then a full search of the database is performed for fingerprint block Y (step 20).

However, if block Y is found to match one or more of the corresponding blocks of the database (step 80), then the result is recorded (step 90) and a fingerprint block for an adjacent position is calculated and the process is repeated. The whole process described in FIG. 3 is continued until all of the fingerprint blocks have been positively identified or are determined as unknown by a full search.

This embodiment can be further improved by examining the similarity between any of the searched fingerprint blocks of the information signal with the corresponding blocks of the database to determine if a match is reliable enough. In other words the history of the matching blocks can be compared. For instance, a reasonable match of fingerprint block X might have been found in the database, that might not have quite been reliable enough to identify the information signal. A reasonable match of the block Y might also have been found in the database that again, on its own, might not be regarded as sufficiently reliable to identify the information signal. However, if the matches of X and Y both relate to the same information signal, then the likelihood of both matches occurring by chance is relatively low i.e. the combined probability of the matches occurring is good enough to reliably identify the information signal being transmitted.

The present invention is suitable for use in conjunction with a number of fingerprinting techniques. For instance, the audio fingerprinting technique of Haitsma et al, as presented in “Robust Audio Hashing For Content Identification”, Content Based Multimedia Indexing 2001, Brescia, Italy, September 2001, computes a sub-fingerprint value for basic windowed time intervals of the audio signal. The audio signal is thus divided into frames, and subsequently the spectral representation of each time frame computed by a Fourier transform. The technique provides a robust fingerprint function that mimics the behaviour of the HAS i.e. it provides a fingerprint mimicking the content of the audio signal as would be perceived by a listener.

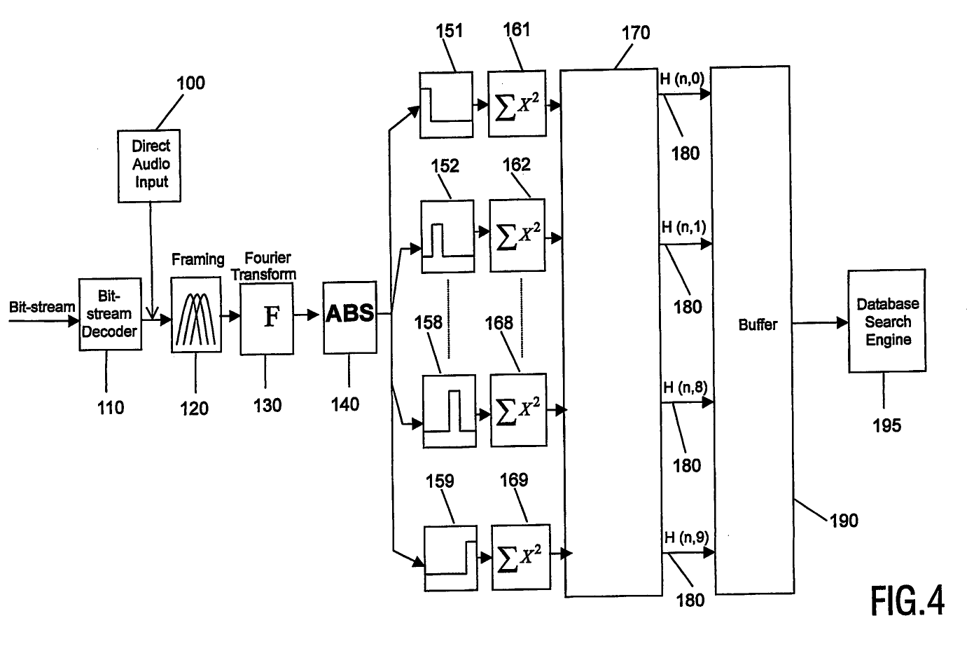

In such a fingerprinting technique, as illustrated in FIG. 4, either an audio signal or a bit-stream incorporating the audio signal can be input.

If a bit-stream signal is being fingerprinted, the bit-stream including the encoded audio signal is received by a bit-stream decoder 110. The bit-stream decoder fully decodes the bit-stream, so as to produce an audio signal. This audio signal is then passed to the framing unit 120.

Alternatively, an audio signal can be received at the Direct Audio Input 100, and passed to the framing unit 120.

The framing unit divides the audio signal into a series of basic windowed time intervals. Preferably, the time intervals overlap, such that the resulting sub-fingerprint values from subsequent frames are largely similar.

Each of the windowed time intervals signals are then passed to a Fourier transform unit 130, which calculates a Fourier transform for each time window. An absolute value calculating unit 140 is then used to calculate the absolute value of the Fourier transform. This calculation is carried out as the Human Auditory System (HAS) is relatively insensitive to phase, and only the absolute value of the spectrum is retained as this corresponds to the tone that would be heard by the human ear.

In order to allow for the calculation of a separate sub-fingerprint value for each of a predetermined series of frequency bands within the frequency spectrum, selectors, 151, 152, . . . , 158, 159 are used to select the Fourier coefficients corresponding to the desired bands. The Fourier coefficients for each band are then passed to respective energy computing stages 161, 162, . . . , 168, 169. Each energy computing stage then calculates the energy of each of the frequency bands, and then passes the computed energy onto the bit derivation circuit which computes and sends to the output 180 a sub-fingerprint bit (H(n,x), where x corresponds to the respective frequency band and n corresponds to the relevant time frame interval). In the simplest case, the bits can be a sign indicating whether the energy is greater than a predetermined threshold. By collating the bits corresponding to a single time frame, a sub-fingerprint is computed for each desired time frame.

The sub-fingerprints for each frame are then stored in a buffer 190 so as to form a fingerprint block. The contents of the buffer is subsequently accessed by a database search engine 195. The database search engine then performs a search, so as to match the fingerprint blocks stored in the buffer 190 with the corresponding fingerprint blocks stored in a database, using the above methods, so as to efficiently identify the information stream (and/or the meta-data associated with the information stream) that was input to the bit-stream decoder 110 or the direct audio input 100.

Whilst the above embodiments of the present invention have been described with reference to audio information streams, it will be appreciated that, the invention can be applied to other information signals, particularly multi-media signals, including video signals.

For instance, the article “J. C. Oostveen, A. A. C. Kalker, J. A. Haitsma, “Visual Hashing of Digital Video: Applications and Techniques”, SPIE, Applications of Digital Image Processing XXIV, Jul. 31-Aug. 3, 2001, San Diego, USA, describes a suitable technique for extracting essential perceptual features from a moving image sequence.

As the technique relates to visual fingerprinting, the perceptual features relate to those that would be viewed by the HVS i.e. it aims to produce the same (or a similar) fingerprint signal for content that is considered the same by the HVS. The proposed algorithm looks to consider features extracted from either the luminance component, or alternatively the chrominance components, computed over blocks of pixels.

It will be appreciated by the skilled person that various implementations not specifically described would be understood as falling within the scope of the present invention. For instance, whilst only the functionality of the fingerprint block generation apparatus has been described, it will be appreciated that the apparatus could be realised as a digital circuit, an analog circuit, a computer program, or a combination thereof

Equally, whilst the above embodiments have been described with reference to specific types of encoding schemes, it will be appreciated that the present invention can be applied to other types of coding schemes, particularly those that contain coefficients relating to perceptually significant information when carrying multimedia signals.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, maybe combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

Within the specification it will be appreciated that the word “comprising” does not exclude other elements or steps, that “a” or “and” does not exclude a plurality, and that a single processor or other unit may fulfil the functions of several means recited in the claims.

The invention can be summarized as follows. Methods and apparatus are described for matching a set input fingerprint blocks, each fingerprint block representing at least a part of an information signal, with fingerprints stored in a database that identify respective information signals. The method includes selecting a first fingerprint block of the set of input fingerprint blocks, and finding at least one fingerprint block in the database that matches the selected fingerprint block. A further fingerprint block is then selected from the set of input blocks, at a predetermined position from the first selected fingerprint block. A corresponding fingerprint block is then located in the database at the same predetermined position relative to the found fingerprint block, and it is determined if the located fingerprint block matches the selected flirter fingerprint block

1. A method of matching a set of input fingerprint blocks, each fingerprint block representing at least a part of an information signal, with fingerprints stored in a database that identify respective information signals, the method comprising the steps of:
selecting a first fingerprint block of said input set of fingerprint blocks;
finding at least one fingerprint block in said database that matches the selected fingerprint block;
selecting a further fingerprint block from said set of fingerprint blocks at a predetermined position relative to said first selected fingerprint block;
locating at least one corresponding fingerprint block in said database at the predetermined position relative to said found fingerprint block; and
determining if said located fingerprint block matches said selected further fingerprint block.

2. A method as claimed in claim 1, the method further comprising iteratively repeating the steps of
selecting a further fingerprint block, locating a corresponding fingerprint block in said database and determining if said located fingerprint block matches said selected further fingerprint block for different predetermined positions relative to the first selected fingerprint block.

3. A method as claimed in claim 1, wherein said predetermined position is an adjacent position.

4. A method as claimed in claim 1, wherein a match in said finding step is deemed to have occurred if the number of differences between the fingerprint block is below a first threshold, and a match in said determining step is deemed to have occurred if the number of differences between the fingerprint blocks is below a second threshold.

5. A method as claimed in claim 4, wherein said second threshold is different from said first threshold.

6. A method as claimed in claim 1, further comprising the steps of: receiving an information signal;
dividing the information signal into sections; and
generating said input block by calculating a fingerprint block for each section.

7. A method of generating a logging report for an information signal comprising the steps of:
dividing the information signal into similar content segments;
generating an input fingerprint block for each segment; and
repeating the method steps as claimed in claim 1 so as to identify each of said blocks.

8. A method as claimed in claim 7, wherein said information signal comprises an audio signal, and wherein each segment corresponds to at least a portion of a song.

9. A computer program arranged to perform the method as claimed in claim 1.

10. A record carrier comprising a computer program as claimed in claim 9.

11. A method of making available for downloading a computer program as claimed in claim 9.

12. An apparatus arranged to match a set of input fingerprint blocks, each fingerprint block representing at least a part of an information signal, with fingerprints stored in a database that identify respective information signals, the apparatus comprising a processing unit arranged to:
select a first fingerprint block of said set of input fingerprint blocks;
find at least one fingerprint block in said database that matches the selected fingerprint block;
select a further fingerprint block from said set of input blocks at a predetermined position relative to said first selected fingerprint block;
locate at least one corresponding fingerprint block in said database at the predetermined position relative to said found fingerprint block; and
determine if said located fingerprint block matches said selected further fingerprint block.

13. An apparatus as claimed in claim 12, further comprising a database arranged to store fingerprints identifying respective information signals and meta-data associated with each signal.

14. An apparatus as claimed in claim 12, further comprising a receiver for receiving an information signal, and a fingerprint generator arranged to generate said set of input fingerprint blocks from said information signal.
